(19) United States
(12) Patent Application Publication
(10) Pub. No.: US 2023/0295399 A1
(43) Pub. Date: Sep. 21, 2023

(54) BORON NITRIDE PARTICLES, METHOD FOR PRODUCING BORON NITRIDE PARTICLES, RESIN COMPOSITION, AND METHOD FOR PRODUCING RESIN COMPOSITION

(71) Applicant: Denka Company Limited, Chuo-ku, Tokyo (JP)

(72) Inventors: Yusuke SASAKI, Chuo-ku, Tokyo (JP); Kenji MIYATA, Chuo-ku, Tokyo (JP); Michiharu NAKASHIMA, Chuo-ku, Tokyo (JP)

(73) Assignee: Denka Company Limited, Chuo-ku, Tokyo (JP)

(21) Appl. No.: 18/041,830

(22) PCT Filed: Aug. 19, 2021
(86) PCT No.: PCT/JP2021/030445

§ 371 Date: Feb. 16, 2023

(30) Foreign Application Priority Data
Aug. 20, 2020 (JP) 2020-139471

(51) Int. Cl. C08K 3/38

(52) U.S. Cl. CPC C08K 3/38; C08K 2003/385

(57) ABSTRACT

A method for producing a boron nitride particle, including a step of disposing a mixture and a base material in a container formed of a carbon material, in which the mixture includes boron carbide and boric acid, and the base material is formed of a carbon material and a step of generating a boron nitride particle on the base material by heating and pressurization with a nitrogen atmosphere formed in the container. A boron nitride particle having a maximum length of 80 μm or longer, and an aspect ratio of 1.5 or more.

### TECHNICAL FIELD

The present disclosure relates to boron nitride particles, a method for producing boron nitride particles, a resin composition, and a method for producing a resin composition.

### BACKGROUND ART

Boron nitride has lubricity, high thermal conductivity and insulating properties and is in use for a variety of uses such as solid lubricating materials, releasing materials, cosmetic raw materials, heat dissipation materials and sintered products having heat resistance and insulating properties.

For example, as a hexagonal boron nitride powder that is loaded into a resin to be capable of imparting high thermal conductivity and high dielectric strength to a resin composition to be obtained, Patent Literature 1 discloses a hexagonal boron nitride powder in which an agglomerated particle composed of the primary particles of hexagonal boron nitride is contained, the BET specific surface area is 0.7 to 1.3 m²/g and an oil absorption that is measured based on JIS K 5101-13-1 is 80 g/100 g or less.

### CITATION LIST

### Patent Literature

[Patent Literature 1] Japanese Unexamined Patent Publication No. 2016-160134

### SUMMARY OF INVENTION

### Technical Problem

As disclosed in Patent Literature 1, in a case where a boron nitride particle is used in, for example, a heat dissipation material, in order to increase thermal conductivity, it is desirable to enlarge the boron nitride particle as much as possible. In addition, in a case where there is a desire to increase thermal conductivity in a specific direction, it is desirable to increase the aspect ratio of the boron nitride particle. However, there is a limit on the size and aspect ratio of a boron nitride particle that is obtained by a conventional production method.

A main objective of the present invention is to provide a new boron nitride particle and a method for producing the same.

### Solution to Problem

One aspect of the present invention is a method for producing a boron nitride particle, including a step of disposing a mixture and a base material in a container formed of a carbon material, in which the mixture includes boron carbide and boric acid, and the base material is formed of a carbon material and a step of generating a boron nitride particle on the base material by performing heating and pressurization with a nitrogen atmosphere formed in the container.

The pressurization may be pressurization at 0.3 MPa or higher.

According to such a production method, a boron nitride particle having a size and an aspect ratio that could not be obtained by a conventional method can be obtained. That is, another aspect of the present invention is a boron nitride particle having a maximum length of 80 μm or longer and an aspect ratio of 1.5 or more.

The maximum length may be 150 μm or longer.

The boron nitride particle may have a shell part formed of boron nitride and a hollow part surrounded by the shell part.

Still another aspect of the present invention is a resin composition containing the boron nitride particle and a resin.

Far still another aspect of the present invention is a method for producing a resin composition, including a step of preparing the boron nitride particle and a step of mixing the boron nitride particle with a resin. This method for producing a resin composition may further include a step of pulverizing the boron nitride particle.

### Advantageous Effects of Invention

According to one aspect of the present invention, it is possible to provide a new boron nitride particle and a method for producing the same.

### BRIEF DESCRIPTION OF DRAWINGS

FIG. 1 is a schematic view showing one embodiment of a pulverized boron nitride particle (boron nitride pulverized particle).

FIG. 2 is a graph of X-ray diffraction measurement results of boron nitride particles of Example 1.

FIG. 3 is a SEM image of the boron nitride particles of Example 1.

FIG. 4 is a SEM image of boron nitride particles of Example 2.

FIG. 5 is a SEM image of boron nitride particles of Example 3.

FIG. 6 is a SEM image of boron nitride particles of Example 4.

FIG. 7 is a SEM image of the boron nitride particles of Example 5.

FIG. 8 is a SEM image of the boron nitride particles of Example 1 after pulverization.

### DESCRIPTION OF EMBODIMENTS

Hereinafter, an embodiment of the present invention will be described in detail. One embodiment of the present invention is a boron nitride particle having a maximum length of 80 μm or longer and an aspect ratio of 1.5 or more.

The boron nitride particle according to one embodiment has excellent thermal conductivity (particularly, thermal conductivity in the longitudinal direction of the boron nitride particle) due to the magnitudes of the maximum length and the aspect ratio. Therefore, this boron nitride particle can be suitably used as a heat dissipation material (heat dissipation sheet). As the use of the boron nitride particle, the heat dissipation material has been exemplified, but the boron nitride particle can be used in a variety of uses without being limited to heat dissipation materials.

In one embodiment, the boron nitride particle may be composed of a plurality of boron nitride pieces. The boron nitride piece is formed of boron nitride and may be a piece having, for example, a flaky shape. In this case, the length of the boron nitride piece in the longitudinal direction may be, for example, 1 μm or longer and may be 10 μm or shorter. The plurality of boron nitride pieces that compose the boron nitride particle may be in physical contact with each other or may chemically bond to each other.

The maximum length of the boron nitride particle may be 100 μm or longer, 125 μm or longer, 150 μm or longer, 175 μm or longer, 200 μm or longer, 225 μm or longer, 250 μm or longer, 300 μm or longer or 350 μm or longer and may be 500 μm or shorter.

The maximum length of the boron nitride particle means the length of the maximum one of direct distances between two arbitrary points on one boron nitride particle when the boron nitride particle is observed with a scanning electron microscope (SEM). The maximum length may be measured by importing the SEM image into image analyzing software (for example, “Mac-view” manufactured by Mountech Co., Ltd.).

In a case where the maximum length of the boron nitride particle is large, it is considered that, when a heat dissipation material has been produced by, for example, mixing the boron nitride particles and a resin, the number of the boron nitride particles that are lined up in the thickness direction of the heat dissipation material becomes small, and heat transfer loss between the boron nitride particles becomes small, and thus the thermal conductivity of the heat dissipation material is superior.

The aspect ratio of the boron nitride particle may be 1.7 or more, 2.0 or more, 3.0 or more, 5.0 or more, or 7.0 or more and may be 12.0 or less, 10.0 or less, 9.5 or less, 9.0 or less, or 8.0 or less.

The aspect ratio of the boron nitride particle is defined as the ratio (L_{A}/L_{B}) of the maximum length (the maximum length in the longitudinal direction) L_{A} of the above-described boron nitride particle to the maximum length of the boron nitride particle in the lateral direction perpendicular to the longitudinal direction where the maximum length L_{A} is present (the maximum length in the lateral direction) L_{B} of the above-described boron nitride particle. The maximum length L_{B} in the lateral direction can be measured by the same method for the maximum length L_{A} in the longitudinal direction.

As the aspect ratio of the boron nitride particle increases, the shape of the boron nitride particle becomes longer and thinner. Therefore, when a heat dissipation material has been produced by, for example, mixing the boron nitride particles with a resin, the boron nitride particles are likely to overlap each other. Furthermore, when a boron nitride particle overlaps another boron nitride particle, it is considered that the boron nitride particle having a long and thin shape overlaps another boron nitride particle so as to be inclined. Therefore, it is considered that the number of the boron nitride particles that are lined up in the thickness direction of the heat dissipation material becomes small, and heat transfer loss between the boron nitride particles becomes small, and thus the thermal conductivity of the heat dissipation material is superior.

The boron nitride particle may be solid or hollow. In a case where the boron nitride particle is hollow, the boron nitride particle may have a shell part formed of boron nitride and a hollow part surrounded by the shell part. The hollow part may be formed along the longitudinal direction of the boron nitride particle or may have a long and thin shape that is an approximately similar shape to the external appearance shape of the boron nitride particle. In addition, in a case where the boron nitride particle is hollow, at least one of both ends of the boron nitride particle in the longitudinal direction may be an open end or both ends may be all open ends. The open end may communicate with the above-described hollow part. In a case where the boron nitride particle is hollow, and at least one of both ends of the boron nitride particle in the direction where the maximum length is present is an open end, for example, when the boron nitride particle is mixed with a resin and used as a heat dissipation material, the resin that weighs less than the boron nitride particle is filled into the hollow part, whereby not only improvement in the thermal conductivity of the heat dissipation material but also the weight reduction of the heat dissipation material can also be expected.

The boron nitride particle may have a cross section where the area proportion of the hollow part in the total area of the shell part and the hollow part is 5% or more. The area proportion of the hollow part of the boron nitride particle can be obtained by importing a cross-sectional image (SEM image) of the boron nitride particle into image analyzing software (for example, “Mac-view” manufactured by Mountech Co., Ltd.) and calculating the area proportion. From the viewpoint of the weight reduction of a heat dissipation material when the boron nitride particle is used for the heat dissipation material, the boron nitride particle may have a cross section where the area proportion is 10% or more, 20% or more, 30% or more, 40% or more or 50% or more and may have a cross section where the area proportion is 90% or less or 80% or less.

The thickness of the shell part may be 50 μm or less and is preferably 30 μm or less and more preferably 15 μm or less from the viewpoint of further reducing the weight of the boron nitride particle. The thickness of the shell part may be 1 μm or more or 3 μm or more from the viewpoint of easily maintaining the shape of the boron nitride particle. The thickness of the shell part is defined as the average value of the lengths of parts of a straight line produced on individual shell parts at the time of producing the straight line where the direct distance between two arbitrary points on a cross section of the boron nitride particle in a direction perpendicular to the longitudinal direction of the boron nitride particle is maximized on an observation image obtained by observing the cross section with SEM.

The boron nitride particle may have a fixed shape or an irregular shape. Examples of the external appearance shape of the boron nitride particle include a spheroid shape, a column shape (rod shape), a plate shape (flat plate shape, curved plate shape or the like), a dumbbell shape and the like. The boron nitride particle may have, for example, a branched structure that is branched in two or more directions.

The boron nitride particle may be substantially composed of boron nitride alone. The fact that the boron nitride particle is substantially composed of boron nitride alone can be confirmed from the fact that only a peak derived from boron nitride is detected in X-ray diffraction measurement.

Subsequently, a method for producing the above-described boron nitride particle will be described below. The boron nitride particle can be produced by, for example, a method for producing a boron nitride particle including a step of disposing a mixture and a base material in a container formed of a carbon material, in which the mixture includes boron carbide and boric acid, and the base material is formed of a carbon material (disposition step) and a step of generating a boron nitride particle on the base material by performing heating and pressurization with a nitrogen atmosphere formed in the container (generation step). Another embodiment of the present invention is such as method for producing a boron nitride particle.

The container formed of a carbon material is a container capable of accommodating the mixture and the base material. The container may be, for example, a carbon crucible. The container is preferably a container airtightness of which can be enhanced by covering an open part with a lid. In the disposition step, for example, the mixture may be disposed on a bottom part of the container, and the base material may be disposed so as to be fixed to a side wall surface in the container or to the inside of the lid. The base material formed of a carbon material may have, for example, a sheet shape, a plate shape or a rod shape. The base material formed of a carbon material may be, for example, a carbon sheet (graphite sheet), a carbon plate or a carbon rod.

The boron carbide in the mixture may be, for example, in a powder form (boron carbide powder). The boric acid in the mixture may be, for example, in a powder form (boric acid powder). The mixture can be obtained by, for example, mixing a boron carbide powder and a boric acid powder by a well-known method.

The boron carbide powder can be produced by a well-known production method. Examples of the method for producing the boron carbide powder include a method in which boric acid and acetylene black are mixed together and then heated at 1800° C. to 2400° C. for one to 10 hours in an inert gas (for example, nitrogen gas) atmosphere, thereby obtaining a massive boron carbide particle. The boron carbide powder can be obtained by appropriately performing pulverization, shieving, washing, impurity removal, drying and the like on the massive boron carbide particle obtained by this method.

The average particle diameter of the boron carbide powder can be adjusted by adjusting the pulverization time of the massive boron carbide particle. The average particle diameter of the boron carbide powder may be 5 μm or more, 7 μm or more or 10 μm or more and may be 100 μm or less, 90 μm or less, 80 μm or less or 70 μm or less. The average particle diameter of the boron carbide powder can be measured by a laser diffraction and scattering method.

The mixing ratio between the boron carbide and the boric acid can be appropriately selected. From the viewpoint of the boron nitride particle being likely to become large, the content of the boric acid in the mixture is, with respect to 100 parts by mass of the boron carbide, preferably 2 parts by mass or more, more preferably 5 parts by mass or more and still more preferably 8 parts by mass or more and may be 100 parts by mass or less, 90 parts by mass or less or 80 parts by mass or less.

The mixture containing boron carbide and boric acid may further contain other components. Examples of the other components include silicon carbide, carbon, iron oxide and the like. When the mixture containing boron carbide and boric acid further contains silicon carbide, it becomes easy to obtain a boron nitride particle having no open end.

In the container, for example, a nitrogen atmosphere containing 95 vol % or more of nitrogen gas has been formed. The content of the nitrogen gas in the nitrogen atmosphere is preferably 95 vol % or more and more preferably 99.9 vol % or more and may be substantially 100 vol %. In the nitrogen atmosphere, not only the nitrogen gas but also ammonia gas or the like may be contained.

From the viewpoint of the boron nitride particle being likely to become large, the heating temperature is preferably 1450° C. or higher, more preferably 1600° C. or higher and still more preferably 1800° C. or higher. The heating temperature may be 2400° C. or lower, 2300° C. or lower or 2200° C. or lower.

From the viewpoint of the boron nitride particle being likely to become large, the pressure at the time of the pressurization is preferably 0.3 MPa or higher and more preferably 0.6 MPa or higher. The pressure at the time of the pressurization may be 1.0 MPa or lower or 0.9 MPa or lower.

From the viewpoint of the boron nitride particle being likely to become large, the time for performing the heating and the pressurization is preferably three hours or longer and more preferably five hours or longer. The time for performing the heating and the pressurization may be 40 hours or shorter or 30 hours or shorter.

According to this production method, boron nitride particles having the above-described maximum length are generated on the base material formed of a carbon material. Therefore, boron nitride particles can be obtained by collecting the boron nitride particles on the base material. The fact that the particles generated on the base material are boron nitride particles can be confirmed from the fact that a peak derived from boron nitride is detected when some of the particles are collected from the base material and X-ray diffraction measurement is performed on the collected particles.

A step of classifying the boron nitride particles obtained as described above so that only a boron nitride particle having a maximum length in a specific range can be obtained out of boron nitride particles having a maximum length of 80 μm or longer and an aspect ratio of 1.5 or more (classification step) may also be performed.

The boron nitride particle obtained as described above can be mixed with a resin and used as a resin composition. That is, still another embodiment of the present invention is a resin composition containing the boron nitride particle and a resin.

Examples of the resin include an epoxy resin, a silicone resin, silicone rubber, an acrylic resin, a phenolic resin, a melamine resin, a urea resin, an unsaturated polyester, a fluorine resin, a polyimide, a polyamide-imide, polyetherimide, polybutylene terephthalate, polyethylene terephthalate, polyphenylene ether, polyphenylene sulfide, wholly aromatic polyester, polysulfone, a liquid crystal polymer, polyethersulfone, polycarbonate, a maleimide-modified resin, an ABS (acrylonitrile-butadiene-styrene) resin, an AAS (acrylonitrile-acrylic rubber styrene) resin, an AES (acrylonitrile ethylene propylene diene rubber styrene) resin and the like.

In the case of using the resin composition as a heat dissipation material, from the viewpoint of improving the thermal conductivity of the heat dissipation material and easily obtaining excellent heat dissipation performance, the content of the boron nitride particles may be 15 vol % or more, 20 vol % or more, 30 vol % or more, 40 vol % or more, 50 vol % or more or 60 vol % or more based on the total volume of the resin composition. From the viewpoint of suppressing the generation of voids at the time of molding the resin composition into a sheet-like heat dissipation material and being capable of suppressing the degradation of the insulating properties and mechanical strength of the sheet-like heat dissipation material, the content of the boron nitride particles may be 85 vol % or less, 80 vol % or less, 70 vol % or less, 60 vol % or less, 50 vol % or less or 40 vol % or less based on the total volume of the resin composition.

The content of the resin may be appropriately adjusted depending on the use, required characteristics or the like of the resin composition. The content of the resin may be, for example, 15 vol % or more, 20 vol % or more, 30 vol % or more, 40 vol % or more, 50 vol % or more or 60 vol % or more and may be 85 vol % or less, 70 vol % or less, 60 vol % or less, 50 vol % or less or 40 vol % or less based on the total volume of the resin composition.

The resin composition may further contain a curing agent that cures the resin. The curing agent is appropriately selected depending on the kind of the resin. Examples of the curing agent that can be used together with an epoxy resin include phenol novolac compounds, acid anhydrides, amino compounds, imidazole compounds and the like. The content of the curing agent may be, for example, 0.5 parts by mass or more or 1.0 part by mass or more and may be 15 parts by mass or less or 10 parts by mass or less with respect to 100 parts by mass of the resin.

The resin composition may further contain other components. The other components may be a curing accelerator (curing catalyst), a coupling agent, a wetting and dispersing additive, a surface conditioner and the like.

Examples of the curing accelerator (curing catalyst) include phosphorus-based curing accelerators such as tetraphenylphosphonium tetraphenylborate and triphenylphosphate, imidazole-based curing accelerators such as 2-phenyl-4,5-dihydroxymethylimidazole, amine-based curing accelerators such as boron trifluoride monoethylamine and the like.

Examples of the coupling agent include a silane-base coupling agent, a titanate-based coupling agent, an aluminate-based coupling agent and the like. Examples of a chemical bonding group that is contained in these coupling agents include a vinyl group, an epoxy group, an amino group, a methacrylic group, a mercapto group and the like.

Examples of the wetting and dispersing additive include phosphate ester salt, carboxylate ester, polyester, acrylic copolymers, block copolymers and the like.

Examples of the surface conditioner include an acrylic surface conditioner, a silicone-based surface conditioner, a vinyl-based surface conditioner, a fluorine-based surface conditioner and the like.

The resin composition can be produced by, for example, a method for producing a resin composition including a step of preparing the boron nitride particle according to one embodiment (preparation step) and a step of mixing the boron nitride particles with a resin (mixing step). Far still another embodiment of the present invention is such as method for producing a resin composition.

The method for producing a resin composition according to one embodiment may further include a step of pulverizing the boron nitride particle (pulverization step). The pulverization step may be performed between the preparation step and the mixing step or may be performed at the same time as the mixing step (the boron nitride particle may be pulverized at the same time as the mixing of the boron nitride particle with the resin).

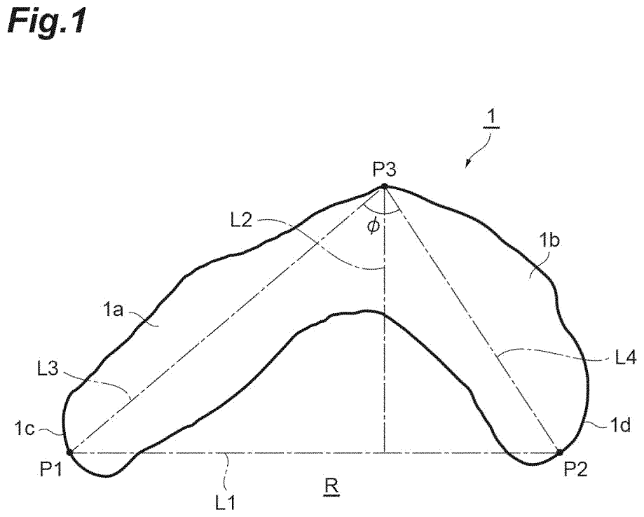

The boron nitride particle pulverized in the pulverization step (hereinafter, also referred to as boron nitride pulverized particle) has a bent shape. FIG. 1 is a schematic view showing one embodiment of the boron nitride pulverized particle. As shown in FIG. 1, in one embodiment, a boron nitride pulverized particle 1 includes, for example, a first portion 1a that extends in a first direction and a second portion 1b that is bent from the first portion 1a and extends in a second direction that is different from the first direction. The fact that the boron nitride pulverized particle has such a bent shape can be confirmed by observing the boron nitride pulverized particle with a scanning electron microscope (SEM). Specifically, on a SEM image of the boron nitride pulverized particle 1, when a straight line L1 connecting an arbitrary point P1 on one end (the end of the first portion 1a) 1c of the boron nitride pulverized particle 1 and an arbitrary point P2 on the other end (the end of the second portion 1b) 1d has been drawn, in a case where it is possible to draw the straight line L1 that pass through a region R where the boron nitride pulverized particle 1 is not present as shown in FIG. 1, the boron nitride pulverized particle 1 is determined to have a bent shape.

The bending condition of the boron nitride pulverized particle can be evaluated with, for example, a bending index that is defined as described below. That is, as shown in FIG. 1, first, on the SEM image of the boron nitride pulverized particle 1, a point P3 where the length of a perpendicular line drawn from the above-described straight line L1 or an extended line thereof to a point on the boron nitride pulverized particle 1 is maximized is determined, and a perpendicular line L2 is drawn from the point P3 to the straight line L1 or the extended line thereof. At this time, the bending index is defined as the ratio of the length of the perpendicular line L2 to the length of the straight line L1 (bending index=the length of the perpendicular line L2/the length of the straight line L1). The length of the straight line L1 and the length of the perpendicular line L2 may be measured by importing the SEM image into image analyzing software (for example, “Mac-view” manufactured by Mountech Co., Ltd.).

As the bending index increases, it means that the boron nitride pulverized particle bends more significantly (at a sharper angle). The bending index of the boron nitride pulverized particle may be 0.2 or more, 0.3 or more, 0.4 or more, 0.5 or more, 0.6 or more, 0.7 or more, 0.8 or more, 0.9 or more, 1.0 or more, 1.5 or more, 2.0 or more or 3.0 or more and may be 10 or less, 8.0 or less, 6.0 or less, 5.0 or less or 4.0 or less. While it is possible to draw a plurality of straight lines L1 on one boron nitride pulverized particle, if it is possible to draw at least one straight line L 1 for which the bending index of the boron nitride pulverized particle is in the above-described range, the bending index of the boron nitride pulverized particle is considered to be in the above-described range. Hereinafter, what has been described above is true for numerical ranges relating to the straight line L1.

The length of the straight line L1 may be 10 μm or longer, 20 μm or longer, 30 μm or longer, 40 μm or longer or 50 μm or longer and may be 150 μm or shorter or 100 μm or shorter. The length of the perpendicular line L2 may be 10 μm or longer, 20 μm or longer, 30 μm or longer, 40 μm or longer or 50 μm or longer and may be 150 μm or shorter or 100 μm or shorter.

The angle formed by the first portion 1a (first direction) and the second portion 1b (second direction) may be 20° to 150°. The angle may be 30° or more, 40° or more, 50° or more or 60° or more and may be 140° or less, 120° or less or 100° or less.

The angle formed by the first portion 1a (first direction) and the second portion 1b (second direction) is defined as described below. That is, as shown in FIG. 1, the point P3 and the point P1 on one end (the end of the first portion 1a) 1c of the boron nitride pulverized particle 1 are connected with a straight line L3, and the point P3 and the point P2 on the other end (the end of the second portion 1b) 1d are connected with a straight line L4. At this time, an angle φ formed by the straight line L3 and the straight line L4 is defined as the angle formed by the first portion 1a (first direction) and the second portion 1b (second direction).

The lengths of the first portion 1a and the second portion 1b may be each independently 10 μm or longer, 20 μm or longer, 30 μm or longer, 40 μm or longer or 50 μm or longer and may be 150 μm or shorter or 100 μm or shorter.

The length of the first portion 1a is defined as the length of the above-described straight line L3. The length of the second portion is defined as the length of the above-described straight line L4. The lengths of the first portion 1a and the second portion 1b may be measured by importing the SEM image into image analyzing software (for example, “Mac-view” manufactured by Mountech Co., Ltd.).

The aspect ratios of the first portion 1a and the second portion 1b may be each independently 1.1 or more, 1.2 or more, 1.3 or more, 1.4 or more, 1.5 or more, 2.0 or more or 3.0 or more and may be 12.0 or less, 10.0 or less, 9.0 or less, 8.0 or less, 7.0 or less or 6.0 or less.

The aspect ratio of the first portion is defined as the ratio (L3/L5) of the length (L3) of the first portion to a maximum length (L5) in a direction perpendicular to the direction where the above-described length is present. The maximum length (L5) in the direction perpendicular to the direction where the length of the first portion is present can be measured by the same method as for the length (L3) of the first portion. The aspect ratio of the second portion is defined by replacing “the first portion” in the above-described definition with “the second portion”.

The resin composition can be used as, for example, a heat dissipation material. The heat dissipation material can be produced by, for example, curing the resin composition. A method for curing the resin composition is appropriately selected depending on the kind of the resin (and the curing agent that is used as necessary) contained in the resin composition. For example, in a case where the resin is an epoxy resin and the above-described curing agent is used together, the resin can be cured by heating, and pressurization may be performed together with the heating.

### EXAMPLES

Hereinafter, the present invention will be more specifically described using examples. However, the present invention is not limited to the following examples.

### Example 1

Massive boron carbide particles were pulverized with a pulverizer, and a boron carbide powder having an average particle diameter of 10 μm was obtained. 100 Parts by mass of the obtained boron carbide powder and 9 parts by mass of boric acid were mixed together and loaded into a carbon crucible, an open part of the carbon crucible was covered with a carbon sheet (manufactured by NeoGraf Solutions), and the carbon sheet was sandwiched by a lid of the carbon crucible and the carbon crucible to fix the carbon sheet. The carbon crucible covered with the lid was heated in a nitrogen gas atmosphere under conditions of 2000° C. and 0.85 MPa for 20 hours in a resistance heating furnace, whereby particles were generated on the carbon sheet.

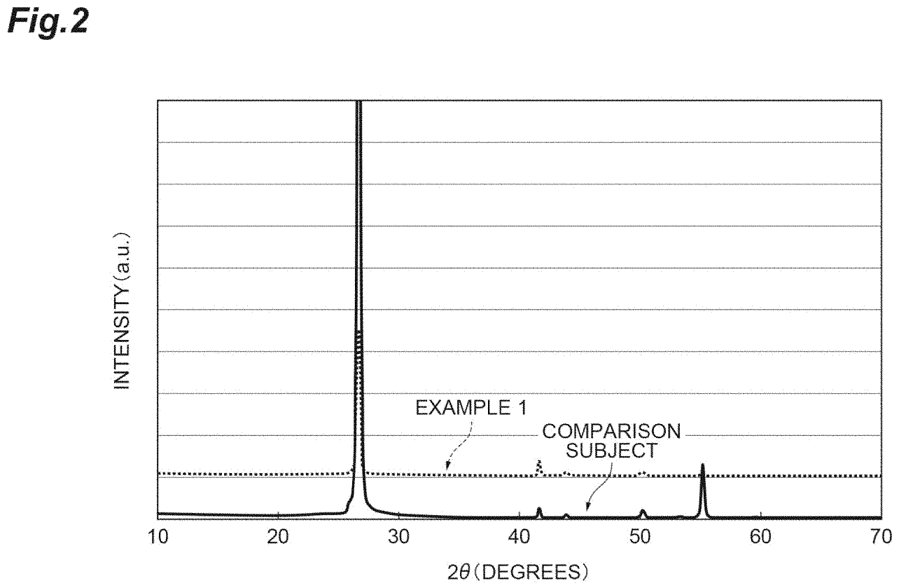

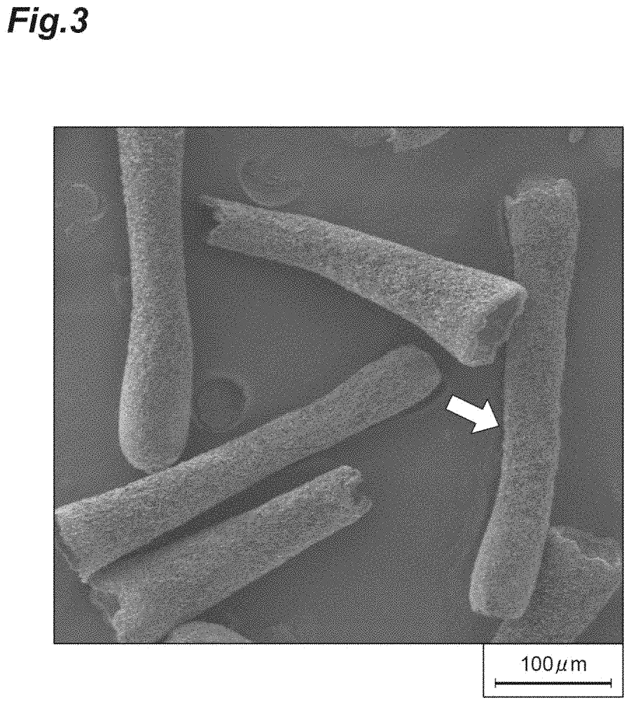

Some of the particles generated on the carbon sheet were collected and measured by X-ray diffraction using an X-ray diffractometer (“ULTIMA-IV” manufactured by Rigaku Corporation). This X-ray diffraction measurement result and the X-ray diffraction measurement result of a boron nitride powder (GP grade) manufactured by Denka Company Limited as a comparison subject are each shown in FIG. 2. As is clear from FIG. 2, only a peak derived from boron nitride was detected, and it was possible to confirm that boron nitride particles were generated. In addition, a SEM image of the obtained boron nitride particles is shown in FIG. 3. One of the obtained boron nitride particles (a boron nitride particle indicated by an arrow in FIG. 3) had a columnar shape. The boron nitride particle had a maximum length of 373 μm and an aspect ratio of 7.5.

### Example 2

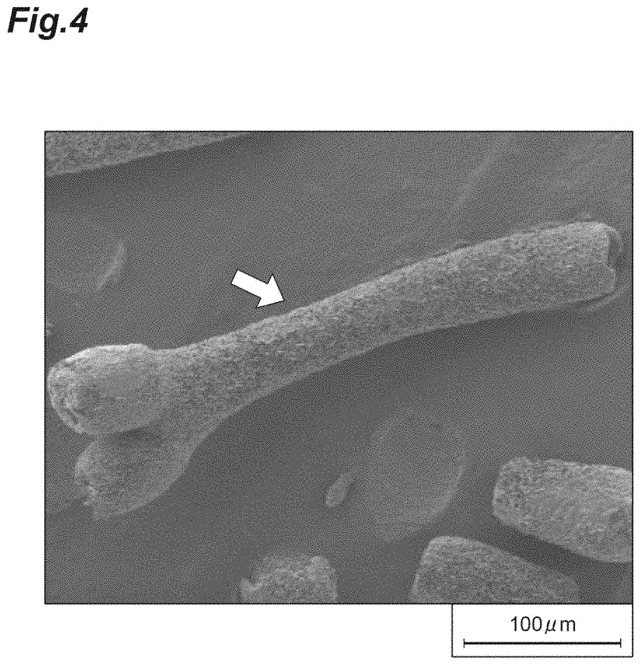

Particles were generated on a carbon sheet under the same conditions as in Example 1 except that the contents of the boron carbide powder and the boric acid in the mixture were changed to 12 parts by mass of boric acid with respect to 97 parts by mass of a boron carbide powder (12.4 parts by mass of boric acid with respect to 100 parts by mass of a boron carbide powder). As a result of collecting some of the particles generated on the carbon sheet and measuring the particles by X-ray diffraction, only a peak derived from boron nitride was detected, and it was possible to confirm that boron nitride particles were generated. A SEM image of the obtained boron nitride particles is shown in FIG. 4. One of the obtained boron nitride particles (a boron nitride particle indicated by an arrow in FIG. 4) had a branched structure that was branched in two directions. The boron nitride particle had a maximum length of 365 μm and an aspect ratio of 8.9.

### Example 3

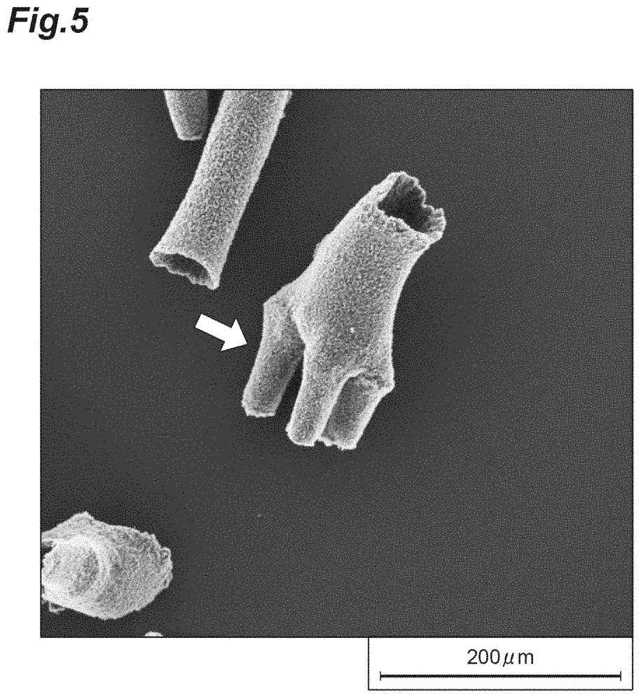

Particles were generated on a carbon sheet under the same conditions as in Example 1 except that the contents of the boron carbide powder and the boric acid in the mixture were changed to 20 parts by mass of boric acid with respect to 100 parts by mass of a boron carbide powder. As a result of collecting some of the particles generated on the carbon sheet and measuring the particles by X-ray diffraction, only a peak derived from boron nitride was detected, and it was possible to confirm that boron nitride particles were generated. A SEM image of the obtained boron nitride particles is shown in FIG. 5. One of the obtained boron nitride particles (a boron nitride particle indicated by an arrow in FIG. 5) had a branched structure that was branched in three directions. The boron nitride particle had a maximum length of 206 μm and an aspect ratio of 1.6.

### Example 4

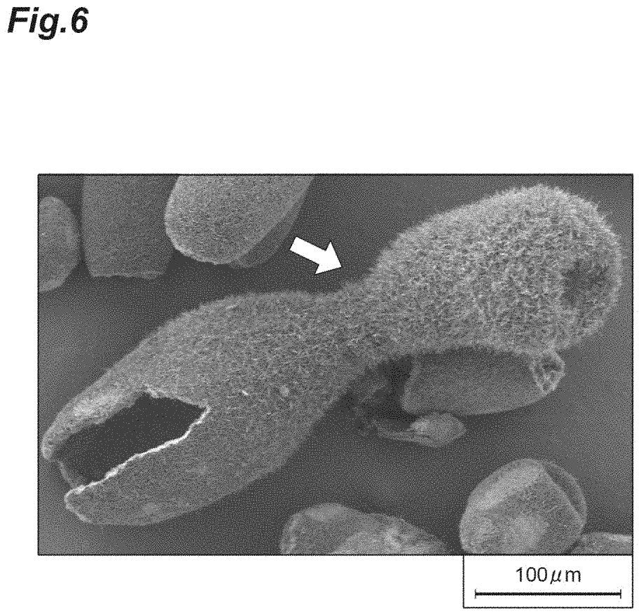

As a result of polishing a surface of a carbon sheet with #80 polishing paper and measuring an arithmetic average roughness in an 800 μm×800 μm range on the polished surface of the carbon sheet using a laser microscope (OPTELICS HYBRID manufactured by Lasertec Corporation), the arithmetic average roughness was 25 Particles were generated on the carbon sheet under the same conditions as in Example 1 except that this polished carbon sheet was used. As a result of collecting some of the particles generated on the carbon sheet and measuring the particles by X-ray diffraction, only a peak derived from boron nitride was detected, and it was possible to confirm that boron nitride particles were generated. A SEM image of the obtained boron nitride particles is shown in FIG. 6. One of the obtained boron nitride particles (a boron nitride particle indicated by an arrow in FIG. 6) had a dumbbell shape. The boron nitride particle had a maximum length of 413 μm and an aspect ratio of 3.3.

### Example 5

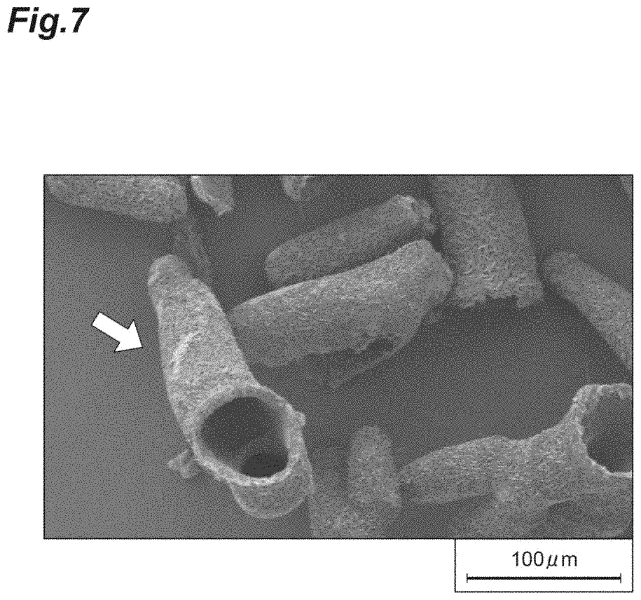

Particles were generated on a carbon sheet under the same conditions as in Example 1 except that the carbon sheet was dried at 200° C. in a dryer for one hour and used. As a result of collecting some of the particles generated on the carbon sheet and measuring the particles by X-ray diffraction, only a peak derived from boron nitride was detected, and it was possible to confirm that boron nitride particles were generated. A SEM image of the obtained boron nitride particles is shown in FIG. 7. One of the obtained boron nitride particles (a boron nitride particle indicated by an arrow in FIG. 7) had a hollow shape. The boron nitride particle had a maximum length of 186 and an aspect ratio of 2.6, and the thickness of a shell part was 3.2 μm. In addition, the boron nitride particle had a cross section where the area proportion of a hollow part was 53%.

### Example 6

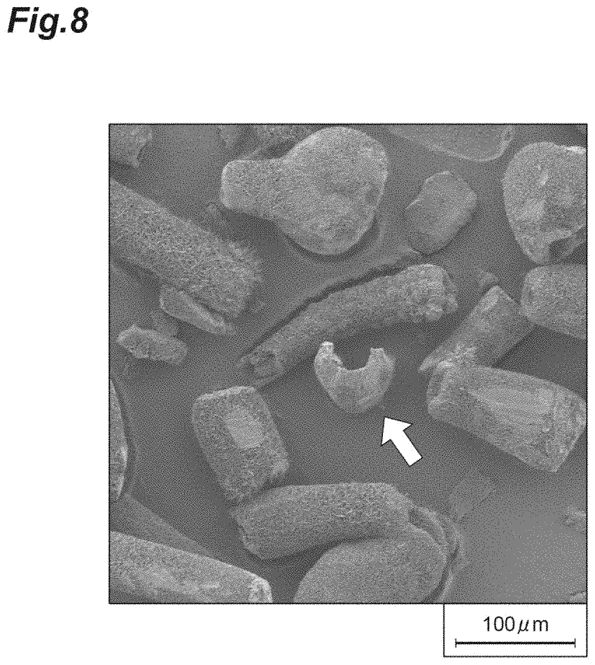

One gram of the boron nitride particles obtained in Example 1 were injected into an aluminum mortar and pulverized using an aluminum pestle for one minute. A SEM image of the pulverized boron nitride particles is shown in FIG. 8. One of the pulverized boron nitride particles (a boron nitride particle indicated by an arrow in FIG. 8) had a bent shape. Subsequently, 100 parts by mass of a naphthalene-type epoxy resin (HP4032 manufactured by DIC Corporation) and 10 parts by mass of an imidazole compound (2E4MZ-CN manufactured by Shikoku Chemicals Corporation) as a curing agent were mixed together, and then 30 parts by mass of the pulverized boron nitride particles were further mixed therewith, thereby obtaining a resin composition. This resin composition was vacuum-defoamed at 500 Pa for 10 minutes and applied onto a PET sheet such that the thickness became 1.0 mm. After that, heating and pressurization were performed for 60 minutes under conditions of a temperature of 150° C. and a pressure of 160 kg/cm², and a 0.5 mm-thick sheet was obtained.

1. A method for producing a boron nitride particle, comprising:
a step of disposing a mixture and a base material in a container formed of a carbon material, wherein the mixture comprises boron carbide and boric acid, and the base material is formed of a carbon material; and
a step of generating a boron nitride particle on the base material by heating and pressurization with a nitrogen atmosphere formed in the container.

2. The method for producing a boron nitride particle according to claim 1,
wherein the pressurization is pressurization at 0.3 MPa or higher.

3. A boron nitride particle having a maximum length of 80 μm or longer, and an aspect ratio of 1.5 or more.

4. The boron nitride particle according to claim 3, wherein the maximum length is 150 μm or longer.

5. The boron nitride particle according to claim 3, comprising:
a shell part formed of boron nitride; and
a hollow part surrounded by the shell part.

6. A resin composition comprising:
the boron nitride particle according to claim 3; and
a resin.

7. A method for producing a resin composition, comprising:
a step of preparing the boron nitride particle according to claim 3; and
a step of mixing the boron nitride particle with a resin.

8. The method for producing a resin composition according to claim 7, further comprising a step of pulverizing the boron nitride particle.
